(19) United States
(12) Patent Application Publication
(10) Pub. No.: US 2026/0243294 A1
(43) Pub. Date: Aug. 20, 2026

(54) FASTENER ASSEMBLY AND TOOLING FOR INSTALLING THE FASTENER ASSEMBLY

(71) Applicants: Ned C. Bowers, Mount Dora, FL (US); Russell Ortner, Apopka, FL (US); David Phillips, The Villages, FL (US)

(72) Inventors: Ned C. Bowers, Mount Dora, FL (US); Russell Ortner, Apopka, FL (US); David Phillips, The Villages, FL (US)

(21) Appl. No.: 19/535,073

(22) Filed: Feb. 10, 2026

Related U.S. Application Data
(60) Provisional application No. 63/759,701, filed on Feb. 18, 2025.

(51) Int. Cl. F16B 39/282; F16B 19/10; F16B 39/24

(52) U.S. Cl. CPC F16B 39/282; F16B 19/109; F16B 39/24

(57) ABSTRACT

An apparatus, including: an insert tool (300) with female threads (310) and a base (304) configured to abut a flat surface and thereby orient the female threads perpendicular to the flat surface; and a flaring assembly (400) having a mandrel (410) and a flare body (420). The mandrel has male threads (412) configured to cooperate with the female threads in the insert tool to advance the mandrel toward the insert tool. The flare body is configured to permit the mandrel to rotate relative to the flare body, to advance with the mandrel, and to flare a sleeve trapped between the insert tool and the flare body when advancing with the mandrel.

### FIELD OF THE INVENTION

The present invention relates to fastener assemblies and installation tooling used to install the fastener assemblies. More particularly, invention pertains to such fastener assemblies secured to a structure via a flared sleeve and installation tooling configured to form the flare.

### BACKGROUND OF THE INVENTION

In the aerospace industry and racing car industry, fastener assemblies are used to secure together two overlapping panels. Typically, multiple of the assemblies are aligned along an edge of the panel and with respective holes in the panels for assembly. The assemblies generally include a cage that is bonded or fastened to a blind side of one of the two panels. The cage may be bonded using known adhesives or fastened with rivets.

An internally threaded insert is secured to the cage with a resilient retaining device such as a clip. A bolt is then inserted through holes in both panels, and with which the cage and inserts are aligned and threaded into the insert.

In other instances, the fastener assembly that is disposed on the blind side may be secured to the panel through a hole in the panel by expanding a portion of the fastener assembly that is disposed in the hole. These known techniques may require difficult and/or tedious positioning of the fastener assembly on the blind side and/or may allow the fastener to rotate during the installation process. In tight spaces, a turned fastener may encounter structure that impedes future replacement of the insert. Consequently, there is room in the art for improvement.

### SUMMARY OF THE INVENTION

In accordance with aspects of the invention, installation tooling may include: an insert tool including female threads and a base end configured to abut a flat surface and thereby orient the female threads perpendicular to the flat surface; and a flaring assembly including a mandrel and a flare body. The mandrel includes male threads configured to cooperate with the female threads in the insert tool to advance the mandrel toward the insert tool. The flare body is configured to permit the mandrel to rotate relative to the flare body, to advance with the mandrel, and to flare a sleeve trapped between the insert tool and the flare body when advancing with the mandrel.

According to other aspects of the invention, a fastener assembly may include: a cage having a base plate, a first wall that is cantilevered from an upper surface of the base plate, and a second wall that is cantilevered from the upper surface of the base plate, wherein the cage defines a channel between the first wall and the second wall; an insert having an internally threaded cylinder that is connected to a respective base, wherein the base of the insert is configured to rest in the channel and on the upper surface; a concave and resilient retention device configured to trap the insert in the channel when the retention device is secured to the first wall and the second wall; a through hole disposed through the base plate, having a counterbore that is recessed from the upper surface, and configured to align with the internally threaded cylinder when the insert is trapped in the channel; and a stem having a hollow cylindrical shape and including a flange at one end, wherein when the flange is disposed in the counterbore an opposite end of the stem protrudes from a bottom surface of the base plate.

According to other aspects of the invention, a method of installing a fastener assembly to a structure, includes: selecting a sleeve from a plurality of sleeves of differing lengths, wherein a length of the sleeve corresponds to a thickness of the structure; placing the sleeve into a through hole in a cage, wherein a first end of the sleeve and the cage cooperate to retain the first end of the sleeve in the through hole; placing an insert on the cage to trap the sleeve in the through hole in the cage; placing a second end of the sleeve in the hole in a structure so that the second end of the sleeve is positioned astride a countersink of the hole in the structure; installing a flaring assembly through the sleeve and into internal threads in the insert; flaring the second end of the sleeve radially outward and into the countersink by advancing the flaring assembly into the internal threads; and removing the flaring assembly

### BRIEF DESCRIPTION OF DRAWINGS

FIGS. 1A and 1B shows an example embodiment of a fastener assembly secured to an angled structure.

FIG. 2 shows an object secured to the angled structure of FIG. 1A via the fastener assembly of FIG. 1A.

FIGS. 3A and 3B are exploded views of the fastener assembly of FIG. 1A.

FIGS. 4A to 4M show an example embodiment of an installation process for installing the fastener assembly of FIG. 1A and an example embodiment of installation tooling.

FIG. 5 shows an alternate example embodiment of an installation process for installing the fastener assembly of FIG. 1A.

FIGS. 6A to 6F show an alternate example embodiment of an installation process for installing the fastener assembly of FIG. 1A and an alternate example embodiment of installation tooling.

FIGS. 7A and 7B show the installation tooling of FIG. 6A.

FIGS. 8A and 8B show an example embodiment of an anti-rotation washer of the fastener assembly of FIG. 1A.

FIGS. 9A and 9B show example embodiments of tabs of the anti-rotation washer of FIG. 8A.

### DETAILED DESCRIPTION OF THE INVENTION

The present inventors have developed a unique and innovative fastener assembly and installation tooling used to install the fastener assembly. The fastener assembly includes a sleeve that can be flared by the installation tooling to secure the fastener assembly to a panel or the like. The fastener assembly includes a cage, an insert, a clip to secure the insert in the cage, and a sleeve to secure the cage to the panel. The sleeve is a separate component. This allows for sleeves of different lengths to be installed in the hole in the cage. Having the option to select a sleeve based on a length of the sleeve allows for installation of the fastener assembly onto panels of various thicknesses. An optional anti-rotation washer may be used to prevent rotation of the cage during the flaring process.

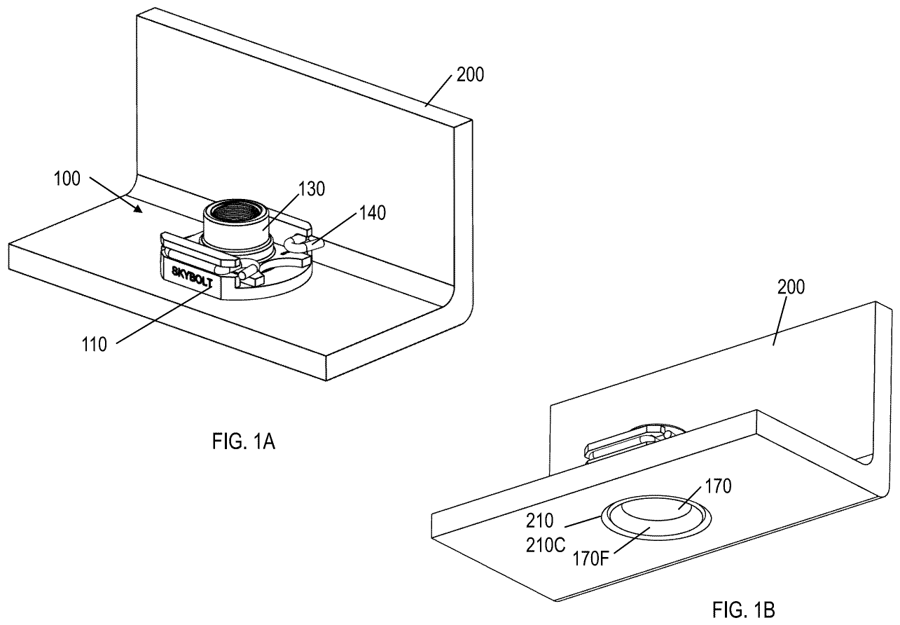

FIGS. 1A and 1B show an example embodiment of a fastener assembly 100 secured to an angled structure 200. The fastener assembly 100 includes a cage 110, an insert 130, a retention device (clip) 140, an optional anti-rotation washer 150 (not visible in FIGS. 1A and 1B), and a sleeve 170. As can be seen in FIG. 1B, the sleeve 170 has a flare 170F that is configured to conform to a countersink 210C of a hole 210 in the angled structure 200. The flare 170F and the countersink 210C cooperate to lock the fastener assembly 100 to the angled structure 200.

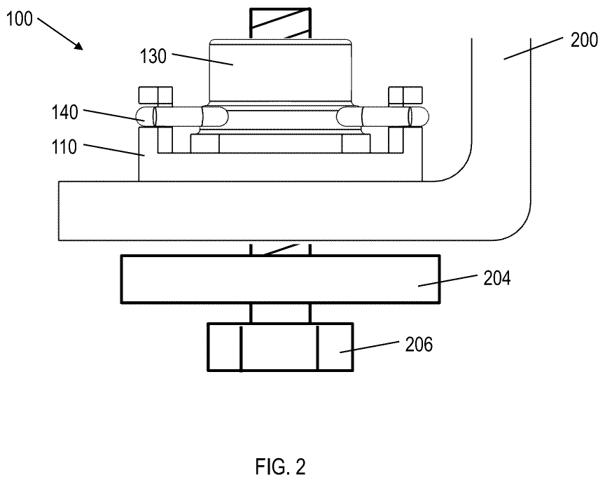

FIG. 2 shows one of many possible ways that the fastener assembly 100 can be used. In this example, an object 204 secured by a bolt 206 to the angled structure 200 via the fastener assembly 100.

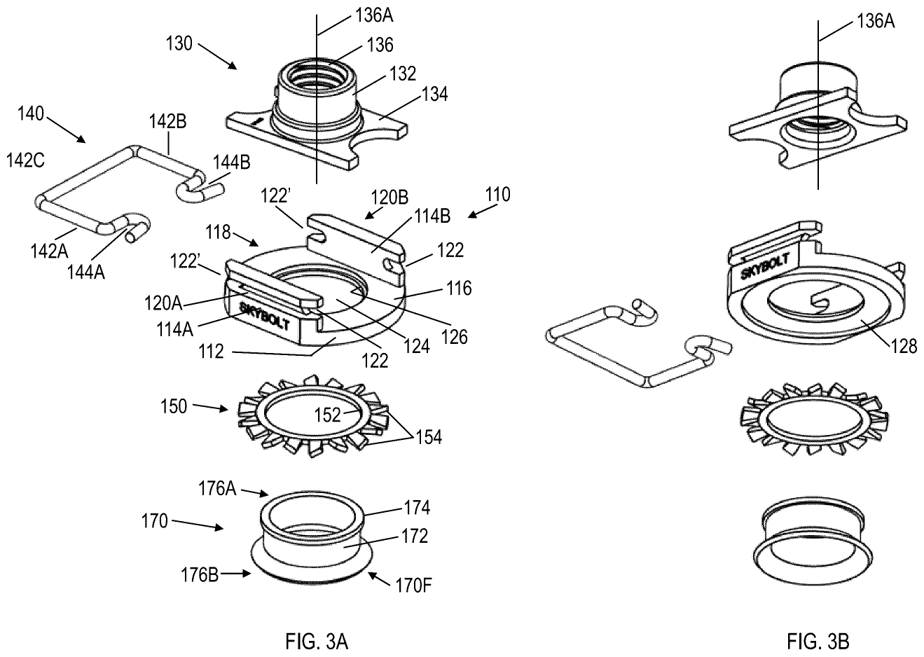

FIGS. 3A and 3B are exploded views of the fastener assembly of FIG. 1A.

The cage 110 includes a base plate 112, a first wall 114A that is cantilevered from an upper surface 116 of the base plate 112 and a second wall 114B that is cantilevered from the upper surface 116 of the base plate 112. The cage 110 defines a channel 118 between the first wall 114A and the second wall 114B. Each wall 114A, 114B includes respective grooves 120A, 120B that define respective notches 122, 122′. The base plate 112 has a through hole 124 with a counterbore 126 recessed into the upper surface 116. Alternately, a countersink can be used in place of the counterbore. The through hole 124 is configured to align with the internally threaded cylinder 132 when the insert 130 is trapped in the channel 118. In an example embodiment, the alignment is concentric, but this is not required. An optional recess 128 is configured to receive at least partly therein the anti-rotation washer 150.

The insert 130 includes an internally threaded cylinder 132 that is connected to a respective base 134 and which has female threads 136. The base 134 of the insert 130 is configured to rest in the channel 118 and on the upper surface 116 and to align a helical axis 136A of the female threads 136 perpendicular to the upper surface 116.

The retention device 140 is composed of a resilient material and has a generally U-shaped configuration including a first leg 142A and a second leg 142B, both of which are interconnected by a third leg 142C (base leg) which is extends to each of the first and second legs 142A, 142B. Respective first ends 144A, 144B of the legs 142A, 142B each have a curvilinear configuration (e.g., U shape/hook shape). When the fastener assembly 100 is assembled, the first leg 142A rests in the first groove 120A of the cage 110, the second leg 142B rests in the second groove 120B of the cage 110, the third leg 142C rests in the notches 122′, and the ends 144A, 144B rest in the respective notches 122. A distance between the ends 144A, 144B is smaller than a corresponding outside diameter of the internally threaded cylinder 132 of the insert 130, which traps the insert 130 in the channel 118.

The anti-rotation washer 150 is configured to be compressed between the cage 110 and the angled structure 200 and to prevent relative rotation therebetween. The anti-rotation washer 150 shown includes an annular ring 152 and a plurality of tabs 154 disposed in an annular array and extending radially outward from the annular ring 152. However, the anti-rotation washer 150 may be any conventional lock washer that prevents relative motion in either the clockwise direction or the counterclockwise direction, depending on the configuration (thread direction) of the installation tools. Examples include an outer tooth lock washer and an inner tooth lock washer. In an example embodiment, the anti-rotation washer 150 is configured to prevent relative rotation in both the clockwise direction and the counterclockwise direction, which distinguishes it from conventional lock washers which are meant to allow relative rotation in one direction to allow for tightening of the associated fastener.

The sleeve 170 includes a cylindrical sleeve body 172, a flange 174 at a first end 176A of the cylindrical sleeve body 172, and once flared, a flare 170F at a second end 176B of the cylindrical sleeve body 172. When installed in the hole 124 in the cage 110, the flange 174 rests in the counterbore 126 of the hole 124. The flange 174 is preferable disposed flush with or below the upper surface 116 so it does not raise the insert 130 off the upper surface 116.

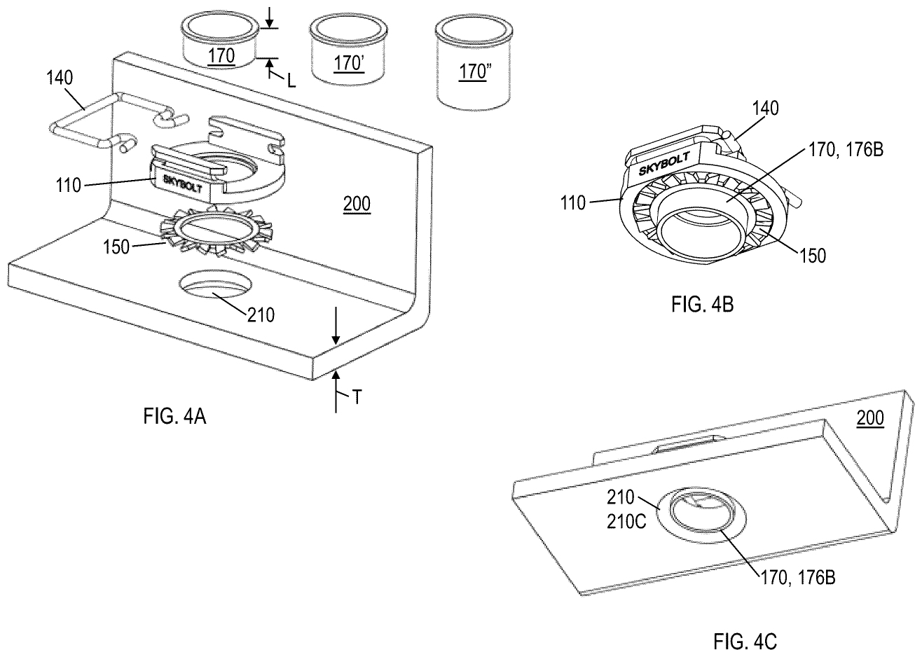

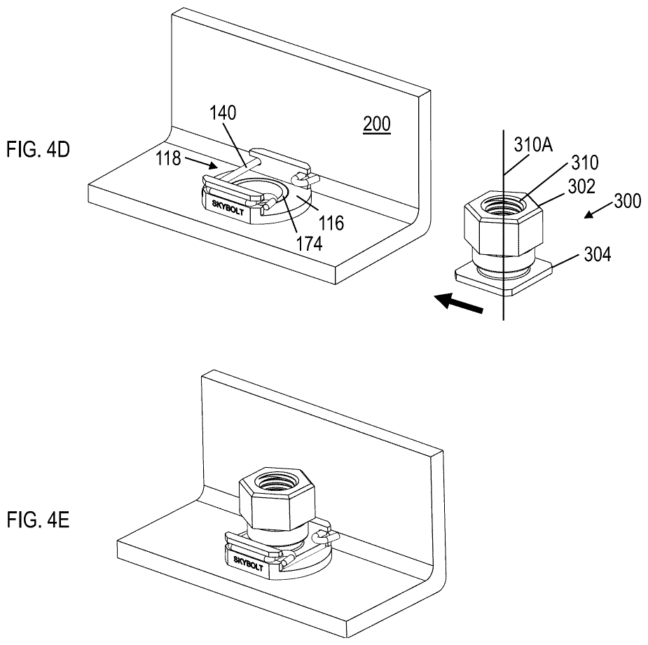

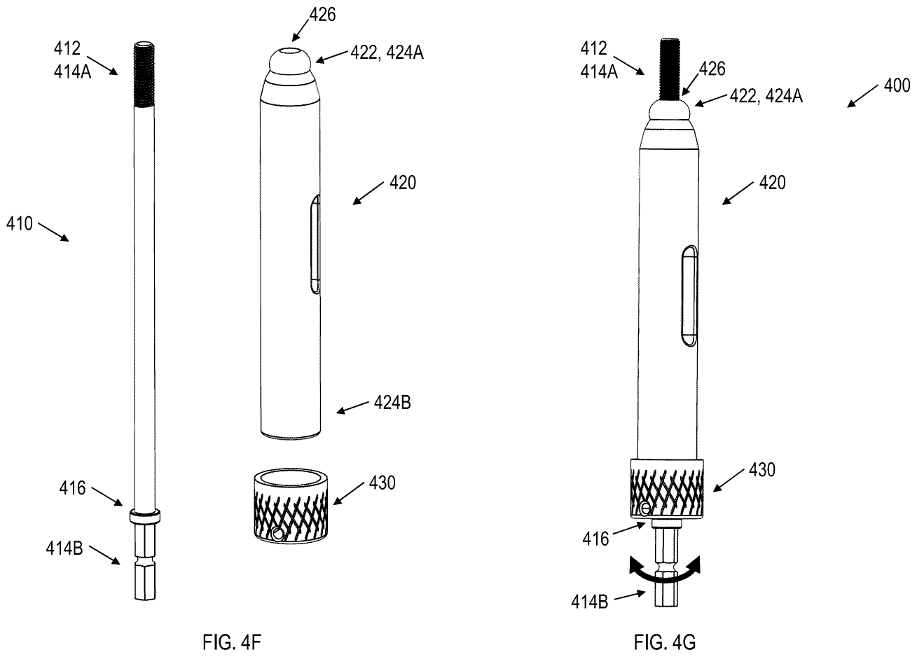

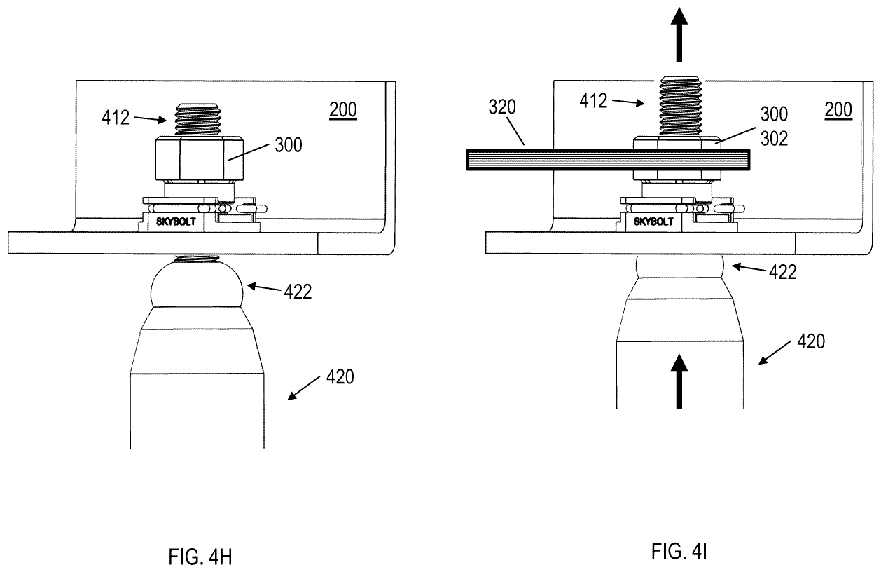

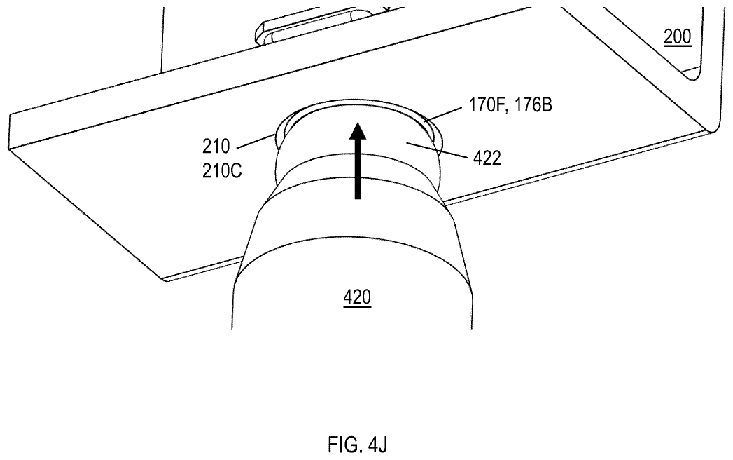

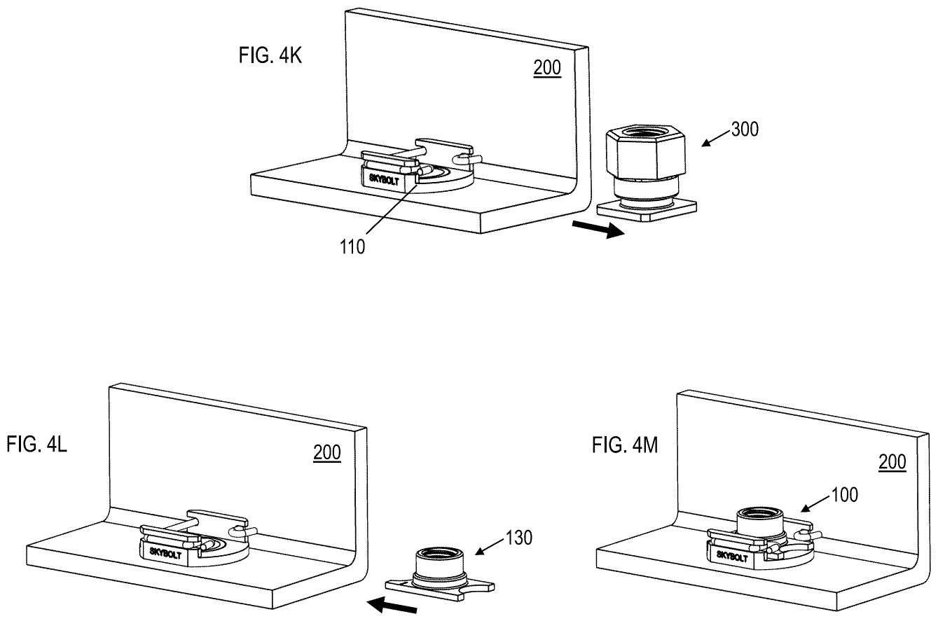

FIGS. 4A to 4M show an example embodiment of an installation process for installing the fastener assembly 100 and an example embodiment of installation tooling.

FIG. 4A shows an exploded vide of the anti-rotation washer 150, the cage 110, the retention device 140, and a variety of unflared sleeves 170, 170′, 170″ before being assembled into the cage 110. The angled structure 200 has a thickness T that can vary from one angled structure 200 to another. Because the sleeve 170 is a separate component, sleeves of differing lengths may be used. The selected sleeve 170 will have a length L suitable for use with the thickness “T” of the respective angled structure 200 to which the fastener assembly 100 will be secured and the associated countersink 210C of the hole 210.

The anti-rotation washer 150, the cage 110, the retention device 140, and the selected sleeve 170 are assembled together as shown in FIG. 4B. Once assembled together, the sleeve 170 protrudes from the cage 110 and the anti-rotation washer 150. The assembled parts are then placed on the angled structure 200 so that the second end 176B of the sleeve 170 protrudes into the countersink 210C in the hole 210. The second end 176B will be flared into the countersink 210C.

As can be seen in the example embodiment shown in FIGS. 4D and 4E, an insert tool 300 with a hexagonal head 302, a base 304, and internal (female) threads 310 is inserted into the channel 118 of the cage 110 and held therein by the retention device 140. The insert tool 300 is configured to cooperate with the cage 110 in essentially the same manner that the insert 130 cooperates with the cage 110. The base 304 rests on the upper surface 116 of the cage 110 and thereby orients a helical axis 310A of the internal threads 310 perpendicular to the upper surface 116.

FIGS. 4F and 4G show an example embodiment of a flaring assembly 400 having mandrel 410, a flare body 420, and a rotary bearing 430 used in conjunction with the insert tool 300 to flare the second end 176B of the sleeve 170.

The mandrel 410 includes male threads 412 at a first end 414A, a second end 414B that is optionally hex shaped, and a shoulder 416. The male threads 412 are configured to cooperate with the female threads 310 of the insert tool 300.

The flare body 420 includes a flare feature 422 at a first end 424A, a second end 424B, and a through hole 426 that passes fully through the flare body 420 from the first end 424A to the second end 424B. The through hole 426 is configured to receive the mandrel 410 therein and to permit the mandrel 410 to rotate within and relative to the flare body 420. The roller bearing 430 is disposed between the second end 424B of the flare body 420 and the shoulder 416 of the mandrel 410.

When assembled together, the mandrel 410 is free to rotate within the flare body 420, the male threads 412 of the mandrel 410 protrude from the first end 424A of the flare body 420, and the second end 414B of the mandrel 410 protrudes from the second end 424B of the flare body 420. This enables an operator to hold the flare body 420 while turning the mandrel 410 therein. The shoulder 416 abuts the roller bearing 430. This ensures that the flare body 420 moves with the mandrel 410.

As can be seen in FIGS. 4H and 4I, the male threads 412 of the mandrel 410 are threaded into the female threads 310 of the insert tool 300. Optionally, a tool 320 such as a wrench can be secured to the hexagonal head 302 of the insert tool 300 to prevent the insert tool 300 from spinning as the mandrel 410 is progressively threaded into the insert tool 300. As the mandrel 410 is rotated the male threads 412 of the mandrel 410 and the female threads 310 of the insert tool 300 cooperate to advance the mandrel toward the second end 176B of the sleeve 170. The shoulder 416 on the mandrel abuts the roller bearing 430 and thereby advances the roller bearing 430 and the flare body 420 with the mandrel 410. The flare body 420 is advanced until the flare feature 422 contacts the second end 176B of the sleeve 170, which is trapped between the insert tool and the flare body 420. After contact is made, the flare body 420 and the associated flare feature 422 are further advanced. This further advancing flares the second end 176B of the sleeve 170 radially outward until the second end 176B is sandwiched between the flare feature 422 and the countersink 210C as can be seen in FIG. 4J. The flare 170F is thereby fully formed at this point, conforms to the countersink 210C, and together with the flange 174 at the other end of the sleeve 170, secures the cage 110 to the angled structure 200.

During the flaring operation, the operator can apply downward force on the flare body 420. The downward force pulls down on the mandrel 410 which, in turn, pulls the insert tool 300 down on the upper surface 116 of the cage. This downward force ensures the sleeve 170 will be fully seated in the counterbore 126 at the end of the flaring process, which eliminates the need for subsequent machining to remove any portion of the sleeve 170 that protrudes above the upper surface 116 after the flaring operation.

The flare may taper outward linearly to match a linearly tapered countersink. Alternately, the flare may taper outward in a nonlinear manner. As used herein, the flare 170F may also be the terminal end of the sleeve 170. The flare 170F disclosed herein is thereby different from a transition between cylindrical sections of different diameters. The flare 170F is also different from a cylindrical section that has been radially expanded from one uniform diameter to a larger uniform diameter. The flare 170F is a linear or non-linear outward spreading of the sleeve 170 at the end of the sleeve 170.

As can be seen in FIGS. 4K to 4M, the flaring assembly 400 is removed from the insert tool 300, the insert tool 300 is removed from the cage 110, and the insert 130 is installed in the cage 110, at which point the installation of the fastener assembly 100 to the angled structure 200 is complete. The completed assembly is shown in FIG. 4M, which is the same as in FIG. 1A.

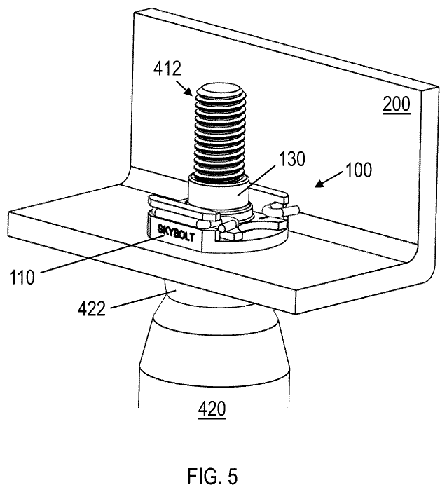

FIG. 5 shows an alternate example embodiment of an installation process for installing the fastener assembly 100. FIG. 5 is comparable to FIG. 4I in the process described above. In this installation process, instead of using the insert tool 300, the insert 130 itself is used in conjunction with the flaring assembly 400. This installation process may be suitable in, for example, instances where there is little to no chance of the cage 110 spinning during the flaring process.

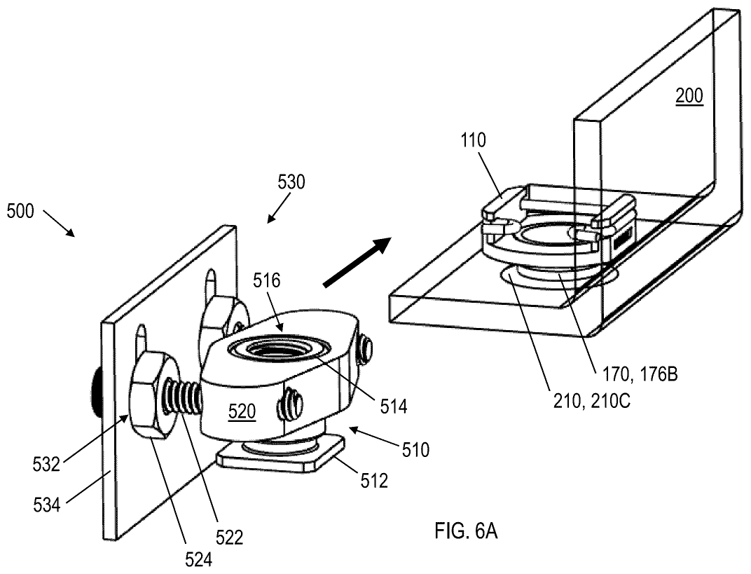

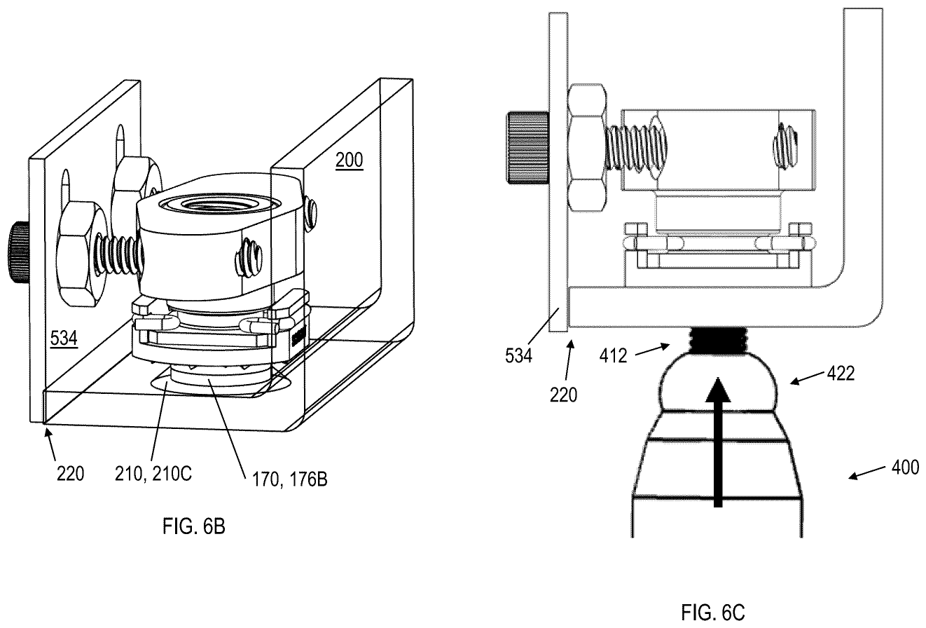

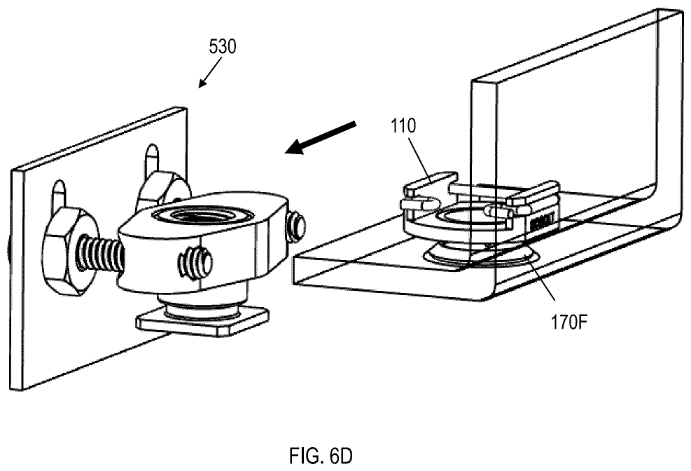

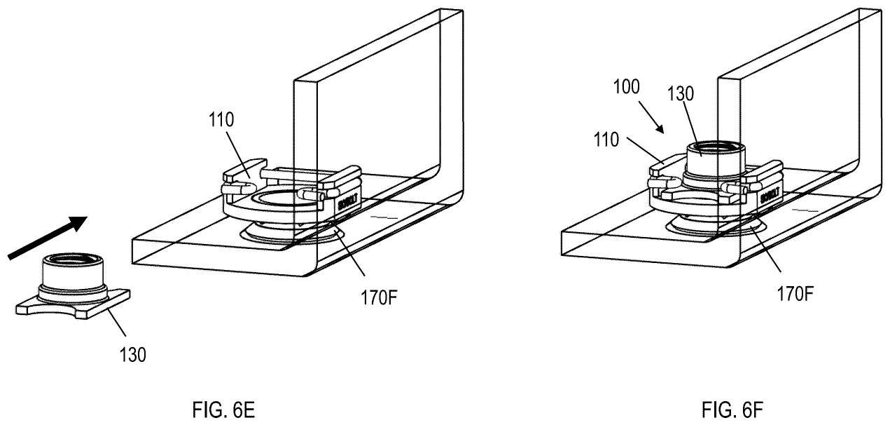

FIGS. 6A to 6F show an alternate example embodiment of an installation process using an example embodiment of an insert tool assembly 500.

The insert tool assembly 500 includes an insert tool 510 with a base 512, a head 514, and internal threads 516 therein. The insert tool 510 can be the insert tool 300 of FIG. 4D with the hexagonal head 302. Alternately, the insert tool 510 can have a head 514 of any shape (e.g., round, as shown). The insert tool assembly 500 further comprises a brace 520 that secures to the head 514 and a brace fixing assembly 530 that prevents the brace 520 from rotating during the flaring process. The brace fixing assembly 530 includes an adjustment assembly 532 and an abutting element 534. The adjustment assembly 532 is configured to secure the abutting element 534 in any position of a range of positions relative to the brace 520 and includes screws 522 and nuts 524. The abutting element is configured to abut an external structure such as the angled structure 200 to prevent rotation of the insert tool 510 which, in turn, prevents rotation of the cage 110 during the flaring operation.

As can be seen in FIG. 6A, the brace 520 is assembled to the head 514 and the adjustment assembly 532 is loosely assembled. The insert tool 510 is positioned in the cage 110 similar to how the insert tool 310 is installed in the cage 110 in FIG. 4E.

As can be seen in FIG. 6A, the abutting element 534 is positioned so that it abuts an edge 220 of the angled structure 200. The adjustment assembly 532 is then tightened so that the insert tool assembly 500 is held in this configuration. (The brace 520 can be tightened before or after the insert tool 510 is positioned in the cage 110.) Typically, there are a multitude of holes 210 distributed along a length of the angled structure 200 and each is at a same distance from an edge 220 of the angled structure 200. Once the insert tool assembly 500 is configured for this distance from the edge 220, the insert tool assembly 500 can be used to install the fastener assembly 100 in all the holes 210 distributed along the length of the angled structure 200 with no need for readjustment, which saves a significant amount of time.

As can be seen in FIG. 6C, the male threads 412 of the flaring assembly 400 are threaded into the internal/female threads 516 of the insert tool 510 and the flaring assembly 400 is advanced until the sleeve 170 is flared, similar to the process shown in FIGS. 4H to 4J. The physical interference between the abutting element 534 and the edge 220 of the angled structure 200 prevents the insert tool assembly 500 from spinning during the flaring process which, in turn, prevents the cage 110 from spinning during the flaring process.

As can be seen 6D to 6F, the flare 170F has been formed, the insert tool assembly 500 is removed from the cage 110, and the insert 130 is installed in the cage 110, at which point the installation of the fastener assembly 100 to the angled structure 200 is complete. The completed assembly is shown in FIG. 6F, which is the same as in FIG. 1A.

To secure a fastener assembly 100 to the angled structure 200 at each of the remaining holes 210 that are distributed along the length of the angled structure 200, the following steps are repeated for each hole 210: 1) the anti-rotation washer 150, the cage 110, the retention device 140, and the sleeve 170 are assembled together and the sleeve 170 thereof is inserted into the respective hole 210; 2) the tightened insert tool assembly 500 is inserted into the cage 110; 3) the sleeve 170 is flared; 4) the tightened insert tool assembly 500 is removed; and 5) and the insert 130 is installed. This process is simple and fast relative to the prior art and thereby represents an improvement over the prior art.

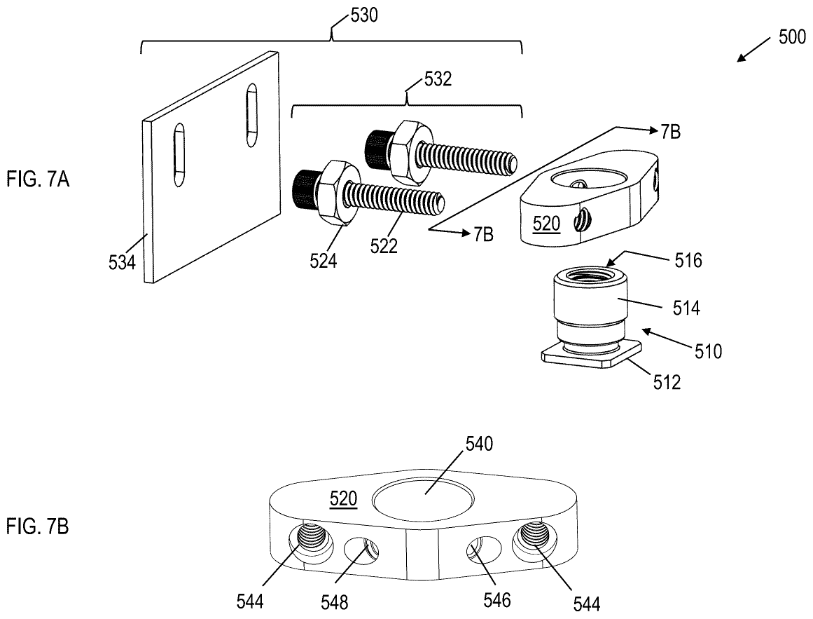

FIG. 7A shows the insert tool assembly 500 of FIG. 6A. FIG. 7B shows the brace 520 of FIG. 7A along line 7B-7B. The brace 520 has a partial or through hole 540 configured to receive therein the head 514 of the insert tool 510. The hole 540 may or may not match a shape of the head 514. For example, if the head 514 has a hex or round shape, the hole 540 may have a hex shape or a round shape respectively. However, this is not necessary. The brace 520 further includes adjustment threads 544 configured to receive the screws 522 of the adjustment assembly 532. The cooperation of the screws 522 and the threads 544 enable positioning of the abutting element 534 in a variety of positions relative to the brace 520. The brace 520 further includes set screws 546 and set screw threads 548 that secure the brace 520 to the head 514 and prevent relative rotation therebetween.

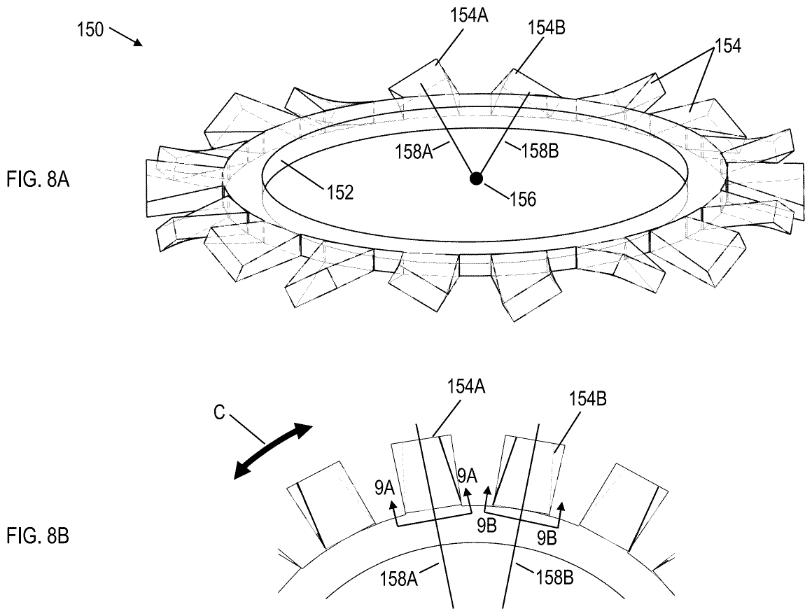

FIGS. 8A and 8B show the example embodiment of the anti-rotation washer 150 of the fastener assembly 100 of FIG. 1A. The anti-rotation washer 150 includes the annular ring 152 and the plurality of tabs 154 disposed in an annular array around and extending radially outward from the annular ring 152. The annular ring 152 is disposed about a center 156 thereof and the plurality of tabs 154 include left twist tabs 154A and right twist tabs 154B when viewed from the center 156 looking radially outward. The tabs 154A, 154B twist about respective radially extending axes 158A, 158B. When viewed from above as shown in FIG. 8B, the left twist tabs 154A would prevent counterclockwise rotation of the anti-rotation washer 150 and the right twist tabs 154B would prevent clockwise rotation of the anti-rotation washer 150. Together, the left twist tabs 154A and the right twist tabs 154B prevent any rotation of the anti-rotation washer 150.

In this example embodiment, the left twist tabs 154A and the right twist tabs 154B are dispersed one then the other in the circumferential direction C of the annular ring 152 and hence they are adjacent to each other. However, other distributions of the left twist tabs 154A and the right twist tabs 154B are feasible.

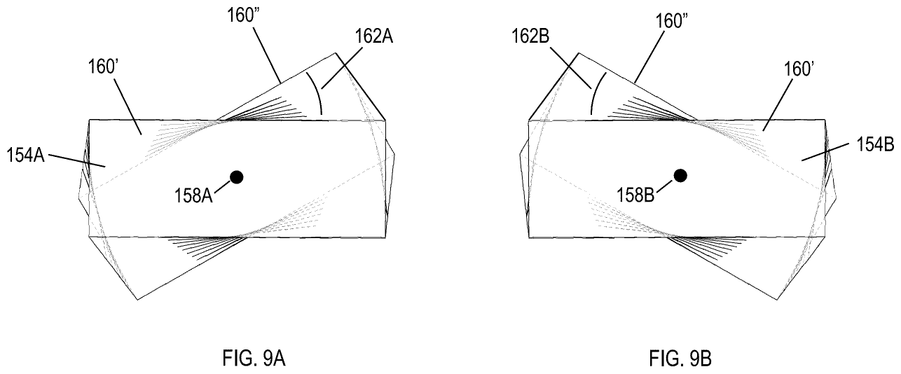

FIGS. 9A and 9B show example embodiments of left twist tabs 154A and the right twist tabs 154B of the anti-rotation washer of FIG. 8A taken along lines 9A-9A and 9B-9B respectively when viewed along the respective radial axis 158A, 158B from the center 156. The left twist tabs 154A twist counterclockwise from a proximate end 160′ to a distal end 160″. The right twist tabs 154B twist clockwise from the proximate end 160′ to the distal end 160″. The left twist tabs 154A twist a left twist angle 162A and the right twist tabs 154B twist a right twist angle 162B. The left twist angle 162A may dispose the distal end 160″ of the left twist tabs 154A at a positive slope as shown in FIG. 9A. The right twist angle 162B may dispose the distal end 160″ of the right twist tabs 154B at a negative slope as shown in FIG. 9B. The left twist angle 162A and the right twist angle 162B may or may not be the same as each other. For example, the twist angle in one direction might be greater than the twist angle in the other direction when a tendency to spin that is prevented by the one twist angle is expected to be greater than a tendency to spin that is prevented by the other twist angle.

An example embodiment of a method for installing the fastener assembly to a structure includes: selecting a sleeve 170 from a plurality of sleeves 170, 170′, 170″ of differing lengths, wherein a length L of the sleeve 170 corresponds to the thickness T of the structure 200; placing the sleeve 170 into the through hole 124 in the cage 110, wherein the first end 176A of the sleeve 170 and the cage 110 cooperate to retain the first end 176A of the sleeve 170 in the through hole 124; placing the insert tool 300 (or the insert 130) on the cage 110 to trap the sleeve 170 in the through hole 124 in the cage 110; placing the second end 176B of the sleeve 170 in the hole 210 in the structure 200 so that the second end 176B is positioned astride the countersink 210C of the hole 210 in the structure 200; installing the flaring assembly 420 through the sleeve 170 and into the internal threads 310 in the insert tool 300; flaring the second end 176B of the sleeve 170 radially outward and into the countersink 210C by advancing the flaring assembly 400 into the internal threads 310; and removing the flaring assembly 420.

The method may further include installing the retention device 140 onto the cage 110 that is effective to retain the insert tool 300 in the channel 118 in the cage 110. The method may also include installing the anti-rotation washer 150 between the cage 110 and the structure 200 that is configured to prevent clockwise and counterclockwise rotation of the cage 110.

As has been disclosed above, the present inventor has devised an apparatus with features that are improvements in the art. All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. An apparatus, comprising:
an insert tool comprising female threads and a base end configured to abut a flat surface and thereby orient a helical axis of the female threads perpendicular to the flat surface; and
a flaring assembly comprising a mandrel and a flare body, wherein the mandrel comprises male threads configured to cooperate with the female threads in the insert tool to advance the mandrel toward the insert tool; and wherein the flare body is configured to permit the mandrel to rotate relative to the flare body, to advance with the mandrel, and to flare a sleeve trapped between the insert tool and the flare body when advancing with the mandrel.

2. The apparatus of claim 1,
wherein the flare body comprises a flare feature at a first end, a second end, and a passage therebetween configured to allow the mandrel to pass through the flare body and to rotate relative to the flare body.

3. The apparatus of claim 2,
wherein the flaring assembly further comprises a roller bearing between the second end of the flare body and the mandrel.

4. The apparatus of claim 2,
wherein the mandrel comprises a threaded end comprising the male threads and a hex shaped end; and
wherein the threaded end is configured to protrude past the flare feature and the hex shaped end is configured to protrude past the second end of the flare body when the mandrel is disposed in the flare body.

5. The apparatus of claim 4,
wherein the mandrel further comprises a shoulder configured to abut the second end of the flare body and to advance the flare body with the mandrel.

6. The apparatus of claim 1,
wherein the insert tool comprises a head comprising a hex shape that is configured to cooperate with a wrench to prevent rotation of the insert tool as the mandrel is threaded into the female threads.

7. The apparatus of claim 1,
wherein the insert tool comprises a head comprising a cylindrical shape; and
wherein the insert tool is part of an insert tool assembly that further comprises a brace configured to be fixed to the head, wherein the brace is elongated in a direction transverse to the female threads.

8. The apparatus of claim 7,
further comprising a brace fixing assembly configured to secure an abutting element thereof to the brace;
wherein the abutting element is configured to extend past the flat surface, to abut an external structure, and to prevent rotation of the brace and the insert tool when abutting the external structure as the mandrel is threaded into the female threads.

9. The apparatus of claim 8,
wherein the brace fixing assembly is configured to secure the abutting element in a range of different positions relative to the brace.

10. A fastener assembly, comprising:
a cage comprising a base plate, a first wall that is cantilevered from an upper surface of the base plate, and a second wall that is cantilevered from the upper surface of the base plate, wherein the cage defines a channel between the first wall and the second wall;
an insert comprising an internally threaded cylinder that is connected to a respective base, wherein the base of the insert is configured to rest in the channel and on the upper surface;
a resilient retention device configured to trap the insert in the channel when the retention device is secured to the first wall and the second wall;
a through hole disposed through the base plate, comprising a counterbore that is recessed from the upper surface, and configured to align with the internally threaded cylinder when the insert is trapped in the channel; and
a stem comprising a hollow cylindrical shape and a flange at one end, wherein when the flange is disposed in the counterbore an opposite end of the stem protrudes from a bottom surface of the base plate.

11. The fastener assembly of claim 10,
wherein when the flange is disposed in the counterbore the upper surface of the flange is flush with or below the upper surface of the base plate.

12. The fastener assembly of claim 10, wherein the opposite end of the stem is configured to be flared by a flaring assembly tool.

13. The fastener assembly of claim 10, wherein the stem is one stem of a plurality of stems; and
wherein stems of the plurality of stems comprise different respective lengths.

14. The fastener assembly of claim 10,
further comprising an anti-rotation washer comprising an annular ring and a plurality of tabs disposed in an annular array and extending radially outward from the annular ring;
wherein when viewed from a center of the annular ring, a distal end of a first tab of the plurality of tabs is oriented at a positive slope and a distal end of a second tab of the plurality of tabs is oriented at a negative slope.

15. The fastener assembly of claim 14,
wherein viewed from the center of the annular ring, the first tab twists counterclockwise about a respective first radial axis, and the second tab of the plurality of tabs twists clockwise about a respective second radial axis.

16. The fastener assembly of claim 15,
wherein the first tab and the second tab are disposed adjacent to each other in a circumferential direction of the annular ring.

17. The fastener assembly of claim 15,
wherein the plurality of tabs comprises a plurality of the first tabs dispersed in the annular array and a plurality of the second tabs disposed in the annular array and interspersed among the plurality of the first tabs in a circumferential direction of the annular ring.

18. The fastener assembly of claim 10,
wherein the first wall and the second wall collectively define a first pair of notches at a first end of the channel and a second pair of notches at a second end of the channel;
wherein the retention device comprises two legs and a base leg there between, wherein each leg of the two legs defines a hook shaped end that is opposite the base leg, wherein the first pair of notches is configured to receive therein the hook shaped ends of the retention device and the second pair of notches is configured to receive therein the base leg of the retention device; and
wherein an outer diameter of the internally threaded cylinder is larger than a distance between the hooked shaped ends of the legs such that when the retention device is installed in the first pair of notches and the second pair of notches the retention device traps the insert in the channel.

19. A method of installing a fastener assembly to a structure, comprising:
selecting a sleeve from a plurality of sleeves of differing lengths, wherein a length of the sleeve corresponds to a thickness of the structure;
placing the sleeve into a through hole in a cage, wherein a first end of the sleeve and the cage cooperate to retain the first end of the sleeve in the through hole;
placing an insert on the cage to trap the sleeve in the through hole in the cage;
placing a second end of the sleeve in the hole in a structure so that the second end of the sleeve is positioned astride a countersink of the hole in the structure;
installing a flaring assembly through the sleeve and into internal threads in the insert;
flaring the second end of the sleeve radially outward and into the countersink by advancing the flaring assembly into the internal threads; and
removing the flaring assembly.

20. The method of claim 19, further comprising:
installing a retention device onto the cage that is effective to retain the insert in a channel in the cage.

21. The method of claim 19, further comprising:
installing an anti-rotation washer between the cage and the structure that is configured to prevent clockwise and counterclockwise rotation of the cage.

22. The method of claim 19, wherein the flaring assembly comprises:
a mandrel comprising male threads that are configured to cooperate with the internal threads in the insert to advance the flaring assembly; and
a flare body configured to receive the mandrel therethrough, to permit the mandrel to rotate therewithin, to advance with the mandrel, and to flare the sleeve as the mandrel advances.

23. The method of claim 19,
wherein the insert is part of an insert tool assembly; and
wherein the insert tool assembly is configured to prevent the insert from being rotated while the mandrel is advanced in the internal threads of the insert by abutting an external part of the structure.
